(19) United States
(12) Patent Application Publication
(10) Pub. No.: US 2023/0310981 A1
(43) Pub. Date: Oct. 5, 2023

(54) ACCESSIBLE GAMING CONTROLLER DEVICE WITH NO-PULL-NO-LIFT OPERATION

(71) Applicant: The AbleGamers Foundation, Inc., Kearneysville, WV (US)

(72) Inventors: Mark BARLET, Kearneysville, WV (US); Christopher POWER, Charlottetown (CA); Graham CHING, Charlottetown (CA); Denaj MILLER, Charlottetown (CA); Muhanad HILANEH, Charlottetown (CA); Ordia Demilade Ryan UNUIGBOJE, Charlottetown (CA)

(21) Appl. No.: 18/296,205

(22) Filed: Apr. 5, 2023

Related U.S. Application Data
(60) Provisional application No. 63/327,526, filed on Apr. 5, 2022.

(51) Int. Cl. A63F 13/24

(52) U.S. Cl. CPC A63F 13/24

(57) ABSTRACT

The present disclosure provides a controller device for assisting those with fine motor impairments. The controller device includes an outer disk body and an inner disk body supported at least in part by the outer disk body and configured to translate relative to the outer disk body. The controller device further includes one or more buttons defined by the outer disk body. The inner disk body is configured to receive a user input that causes the inner disk body to translate relative to the outer disk body and actuate at least one of the one or more buttons. The one or more buttons are disposed radially about a peripheral edge of the outer disk body, and an input element operably connected to the inner disk body is configured to cause translation of the inner disk body in a direction responsive to receipt of an applied user input via the input element.

### CROSS-REFERENCE TO RELATED APPLICATIONS

This patent application claims priority to Provisional Application Ser. No. 63/327,526 entitled “Accessible Gaming Controller Device with No-Pull-Lift Operations,” filed Apr. 5, 2022, the contents of which are incorporated herein by reference in its entirety.

### TECHNOLOGICAL FIELD

Embodiments of the present disclosure relate generally to gaming accessories and, in particular, to an accessible gaming controller device.

### BACKGROUND

Traditionally, video game controllers often require two hands to control in-game maneuvers and to also support the weight of the physical controller device. A user may be required to use, for example, several fingers (e.g., little finger, ring finger, middle finger, etc.) on each hand to support the controller and their remaining fingers (e.g., thumb and index finger) to perform the inputs to the controller via one or more buttons, knobs, joysticks, or the like. Such controllers may require the user to lift and/or hold the controller such that their fingers are able to be placed at the appropriate positions. For users with fine motor impairments or physical disabilities, however, it may be difficult to lift and/or maneuver such a controller into particular positions and to maintain such a position during use.

Applicant has identified a number of deficiencies and problems associated with conventional controllers and associated gaming and entertainment systems. Through applied effort, ingenuity, and innovation, many of these identified problems have been solved by developing solutions that are included in embodiments of the accessible gaming controller device as described in detail herein.

### BRIEF SUMMARY

Example embodiments of the present disclosure provide an accessible controller device. The controller device may include an outer disk body and an inner disk body supported at least in part by the outer disk body. The inner disk body may be configured to translate relative to the outer disk body. The controller device may further include one or more buttons defined by the outer disk body. The inner disk body may be configured to receive a user input that causes the inner disk body to translate relative to the outer disk body and actuate at least one of the one or more buttons.

In some embodiments, the one or more buttons may be disposed radially about a peripheral edge of the outer disk body.

In some embodiments, the controller may further include an input element operably connected to the inner disk body and configured to cause translation of the inner disk body in a direction responsive to receipt of an applied user input via the input element.

In some embodiments, the controller may further include a housing defining an interior configured to support the outer disk body and the inner disk body therein and a top plate configured to cover at least a portion of the interior of the housing.

In some further embodiments, the top plate may be removably attached to the housing so as to provide selective access to the interior of the housing. In such an embodiment, the top plate may further include an opening configured to receive an input element operably connected to the inner disk body therein such that the input element extends at least partially through the opening.

In some embodiments, the housing may define one or more openings defined by a bottom surface of the housing opposite the top plate.

In some further embodiments, the one or more openings of the bottom surface may be configured to communicably couple the controller device to a gaming system via one or more cables disposed within the one or more openings.

In some embodiments, the inner disk body may further define a plurality of radial slots, and the controller device may further include a plurality of slide pins configured to be positioned within respective radial slots of the plurality of radial slots.

In some embodiments, each slide pin may define a limb configured to slot within the respective radial slot.

In some embodiments, the outer disk body may further define a plurality of slide channels, each slide channel defining a translation path to a respective button of the one or more buttons.

In some further embodiments, the translation path may define a linear path along which the respective slide pin travels.

In some further embodiments, each button of the one or more buttons may be positioned at a distal end of a respective translation path.

In some still further embodiments, in response to a user input, the slide pin may translate along the translation path in a first direction so as to actuate a first button positioned at the distal end of the translation path in the first direction.

In some embodiments, the controller device may further include a reset mechanism configured to, following removal of a user input, reset the inner disk body to a resting position.

In some further embodiments, the reset mechanism may include a plurality of springs configured to urge the inner disk body to the resting position.

In some still further embodiments, each of the plurality of springs may be configured to urge the inner disk body in a direction opposite a direction associated with a user input configured to actuate a respective button.

In other embodiments, the outer disk body may further define a plurality of arcuate shapes positioned at respective buttons along a peripheral edge of the outer disk body. In such an embodiment, the plurality of arcuate shapes may be configured to preclude an unintended actuation of one or more buttons and/or direct movement of the inner disk body towards a respective one of the one or more buttons.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a perspective view of example accessible gaming controller device in accordance with some embodiments.

FIG. 2 illustrates a top view of the accessible gaming controller device of FIG. 1 in accordance with some embodiments.

FIGS. 3A-3B illustrate top views of the inner disk body of the example accessible gaming controller device of FIG. 1 in a resting and in an actuated position, respectively, in accordance with some embodiments.

FIG. 4 illustrates a side section view of the accessible gaming controller device in a resting position, in accordance with some embodiments.

FIG. 5 illustrates an exploded view of the accessible gaming controller device of FIG. 1 and a housing in accordance with some embodiments.

FIG. 6 illustrates an isometric view of the accessible gaming controller device of FIG. 5 assembled in the housing.

FIG. 7 illustrates an isometric view of another example accessible gaming controller device in accordance with some embodiments.

FIG. 8 illustrates a top view of the example accessible gaming controller device of FIG. 7 in accordance with some embodiments.

FIGS. 9A-B illustrate top views of the example accessible gaming controller device of FIG. 7 highlight arcuate shaped contours.

FIG. 10 illustrates a top view of the example accessible gaming controller device of FIG. 7 in an actuated position in accordance with some embodiments.

FIGS. 11A-11C illustrate detailed views of the example accessible gaming controller device of FIG. 7 transitioning from a resting position to an actuated position in accordance with some embodiments.

FIG. 12 illustrates a detailed and enlarged view of the example accessible gaming controller device of FIG. 7 in accordance with some embodiments.

FIGS. 13A-13B illustrate side section views of the example accessible gaming controller device of FIG. 7 in accordance with some embodiments while in the resting position.

FIG. 14 illustrates an exploded view of the example accessible gaming controller device of FIG. 7 and a housing in accordance with some embodiments.

FIG. 15 illustrates an isometric view of the accessible gaming controller device of FIG. 7 assembled in the housing.

FIGS. 16A-16D illustrate example implementations of the accessible gaming controller devices of the present disclosure.

FIGS. 17A-17E illustrate various views of example embodiments of accessible gaming controller devices of the present application.

### DETAILED DESCRIPTION

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, terms such as “front,” “rear”, “side,” “top,” etc. are used for explanatory purposes in the examples provided below to describe the relative position of certain components or portions of components. Additionally, the example embodiments of the present invention may be described in conjunction with reference to an Xbox Adaptive Controller (XAC) of Microsoft® Corporation as the receptive destination device; however, the embodiments of the present invention may be equally applicable for use with other forms of gaming controllers (e.g., PlayStation® controllers of Sony® Corporation, Wii® controllers of Nintendo®, Nintendo Switch of Nintendo®, or the like) of any manufacturer without limitation. Furthermore, the accessible gaming controller devices described herein may be configured for use with any computing device, mobile device, electronic device, and/or the like such that data (e.g., input data generated in response to user inputs to the controller) may be transmitted between the accessible gaming controller device and such an example computing device. Such input data may be used to control operation of a, for example, video game, web application, and/or the like hosted by or otherwise accessed via the example computing device.

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements.

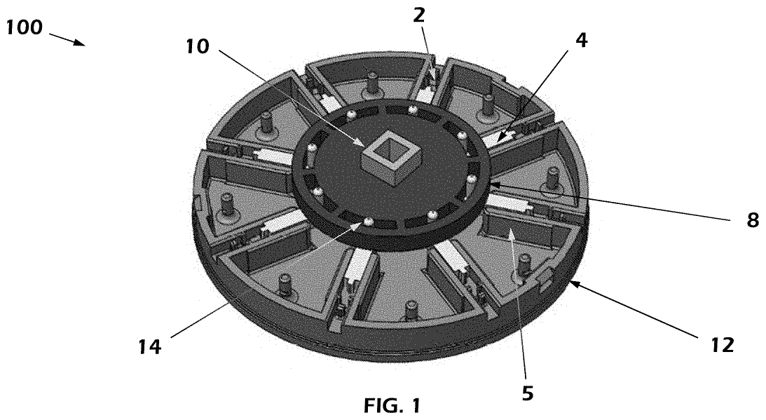

With reference to FIG. 1, an example accessible gaming controller device 100 (e.g., controller 100) is illustrated. The controller 100 may include an inner disk body 8 and an outer disk body 12. As shown, the inner disk body 8 may be nested within and/or supported by an outer disk body 12. For example, the inner disk body 8 may be at least partially disposed within an interior recess, cavity, and/or the like defined by the outer disk body 12. The inner disk body 8 may be configured to translate relative the outer disk body 12. The controller 100 may further include a plurality of slide pins 4, a plurality of slide channels 5, a plurality of buttons 2, a plurality of limbs 14, and an interlocking mechanism 10 as illustrated in FIG. 1. The inner disk body 8 may be linked, attached, or otherwise engaged with the outer disk body 12 via the plurality of slide pins 4. Although described herein as attached via the plurality of slide pins 4, the present disclosure contemplates that the inner disk body 8 may be moveably attached to the outer disk body 12 via any number of ways so long as the inner disk body 8 is capable of causing movement of at least one slide pin in a direction of a respective button 2 so as to actuate the button 2. To this end, the plurality of buttons 2 may be disposed radially about a peripheral edge of the outer disk body 12.

The plurality of slide pins 4 may be configured or otherwise formed in any number of different shapes, sizes, configurations (e.g., rectangular, cylindrical, conical, etc.) based upon the intended application of the controller 100. In any embodiment, each slide pin 4 may be configured to receive an input (e.g., from a user or otherwise) that causes motion of the inner disk body 8. Such a user input may cause a slide pin 4 to translate within a respective slide channel 5 of the outer disk body 12. As would be evident in light of the present disclosure, the inner disk body 8 may have a neutral or resting position prior to receiving a user input in which the inner disk body 8 is centrally located (e.g., in an instance in which the inner disk body 8 and the outer disk body 12 are concentric shapes) within the outer disk body 12. Upon receiving a user input that causes movement of the inner disk body 8 relative the outer disk body 12, the slide pins 4 may translate along a translation path defined by the respective slide channel 5. By way of a particular example, the translation path may terminate at a distal end of the slide channel 5 at which a button 2 is positioned (e.g., at the peripheral edge of the outer disk body 12). The plurality of slide channels 5 of the outer disk body 12 may be manufactured as a whole (e.g., an integrated or integral body) or made be formed of individual or modular components. The slide channels 5 may be designed in any number of complimentary shapes, sizes, configurations (e.g., rectangular, cylindrical, conical, etc.) so as to provide a pathway for the slide pins 4 based upon the intended application of the controller 100.

The plurality of buttons 2 may be defined or otherwise housed by the outer disk body 12. Each of the plurality of buttons 2 may be configured to generate input data for transmission to, for example, a gaming system operably connected with the controller 100. In some embodiments, the plurality of buttons 2 may be mechanical in nature or operation such that actuation of one of the buttons 2 refers to the physical contact between a slide pin 4 and the button 2 that causes physical movement, deflection, etc. of the button 2. In other embodiments, the plurality of buttons 2 and the plurality of slide pins 4 may be configured to complete an electrical circuit when contact between a particular button 2 and an associated slide pin 4 occurs. For example, contact between the button 2 and the slide pin 4 may complete a circuit that indicates a user input at the particular button 2. An example user input may be applied to cause movement of the inner disk body 8 in a direction responsive to receipt of an applied user input via an input element (not shown). For example, the input element (not shown) may be attached to the inner disk body 8 via an interlocking mechanism 10. Each button of the plurality of buttons 2 may be configured to correspond to a particular intended user input. For example, a first button may correspond to an ‘A’ button on a standard controller while second button may correspond to an ‘X’ button on the standard controller.

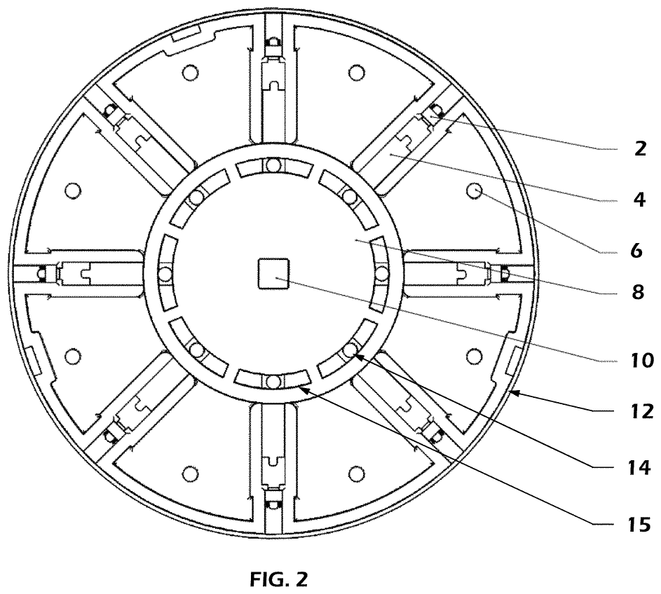

With reference to FIG. 2, a top view of the controller 100 is provided. As shown in FIG. 2, each slide pin 4 may be connected to the inner disk body 8 via a limb 14. The limb 14 may be configured to translate planar motion of the user input, such as a user input provided to an input element attached to the inner disk body 8, to a linear motion of the slide pins 4 attached thereto. Each limb 14 of a respective slide pin 4 may be configured to operably connect the inner disk body 8 with the slide pin 5 via receipt of the respective limb 14 within a radial slot 15 of the inner disk body 8. The radial slots 15 provide a limited range of motion for the limbs 14 positioned therein. The plurality of slide pins 4 may be configured to translate such that the slide pins 4 extend in the direction of user input towards a desired button 2. For example, in response to a user input, the slide pin 14 translates along the translation path in a first direction so as to actuate a first button positioned at the distal end of the translation path in the first direction. As would be evident in light of the present disclosure, actuation of a particular slide pin (e.g., first slide pin) in a first direction towards the peripheral edge of the outer disk body 12 results in movement of an opposing a slide pin 4 positioned opposite the first slide pin towards the center of the controller 100 (e.g., radially inward towards the center). The range of motion achievable by each of the slide pins 4 may be based upon the intended application of the controller 100 (e.g., component size, product size, number of buttons, etc.).

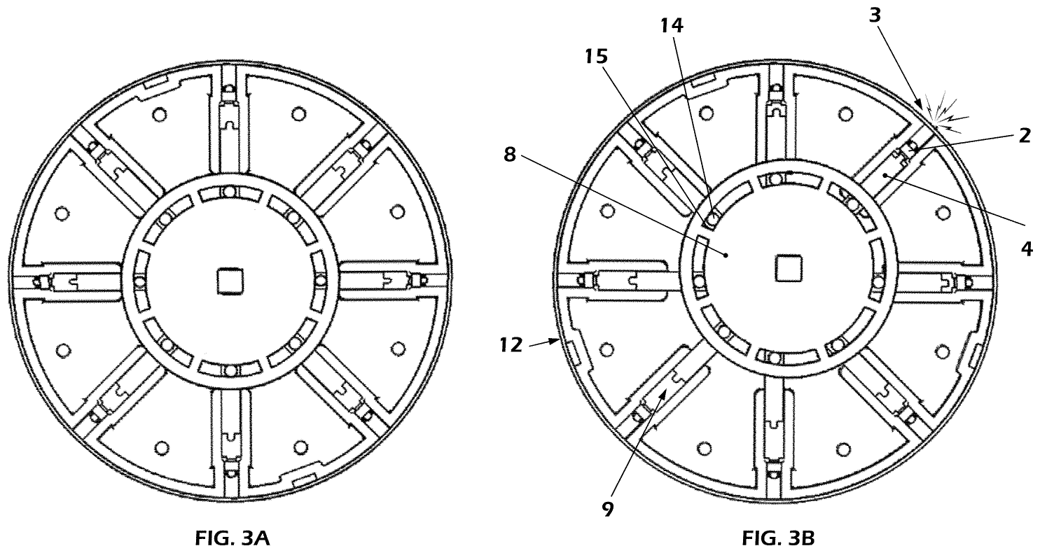

With reference to FIGS. 3A-3B, a planar translation of the inner disk body 8 from a resting position (e.g., 3A) towards a desired button 2 (e.g., FIG. 3B) is shown. This planar translation may be in response to a received user input as described above. The motion of the inner disk body 8 forces a slide pin 4 to extend towards a desired button 2 causing actuation 3 at an instance when, for example, the maximum reach is achieved. The opposing slide pin 9 displays the minimum reach of any of the slide pins 4. The plurality of slide pins 4 remain in their respective linear translation paths as defined by the respective slide channels 5. However, the location of the corresponding limbs 14 within the radial slots 15 may shift in response to the user input. Thus, the radial slots 15 may also limit the range of motion of the inner disk body 8.

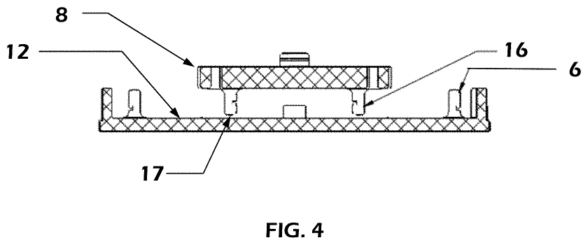

With reference to FIG. 4, a cross sectional side view of the disk assembly is provided. As shown, a plurality of inner spring perches 16 may be formed as part of the inner disk body 8. The plurality of outer spring perches 6 may also be manufactured as part of the outer disk body 12. The inner spring perch 16 and outer spring perch 6 may be connected by a mechanical spring or other types of tension or compression mechanisms (e.g., pressurized cylinders, load absorbing devices, etc.). Such mechanisms (e.g., reset mechanisms) may be attached by an appropriately sized groove or hole in either inner spring perch 16 or outer spring perch 6. The height of the inner spring perch 16 may be designed to set the overall height of the controller 100. In some embodiments, the distal end 17 of the inner spring perch 16 may be configured to rest and/or glide on the surface of the outer disk body 12. The compression or tension devices (e.g., reset mechanisms) may be configured to apply a force to maintain a tolerance between the plurality of inner spring perches 16 and the surface of the outer disk body 12. Said differently, the reset mechanism may include a plurality of springs configured to urge the inner disk body 8 to the resting position as shown in FIG. 3A. For example, each of the plurality of springs may be configured to urge the inner disk body 8 in a direction opposite a direction associated with a user input configured to actuate a respective button 2.

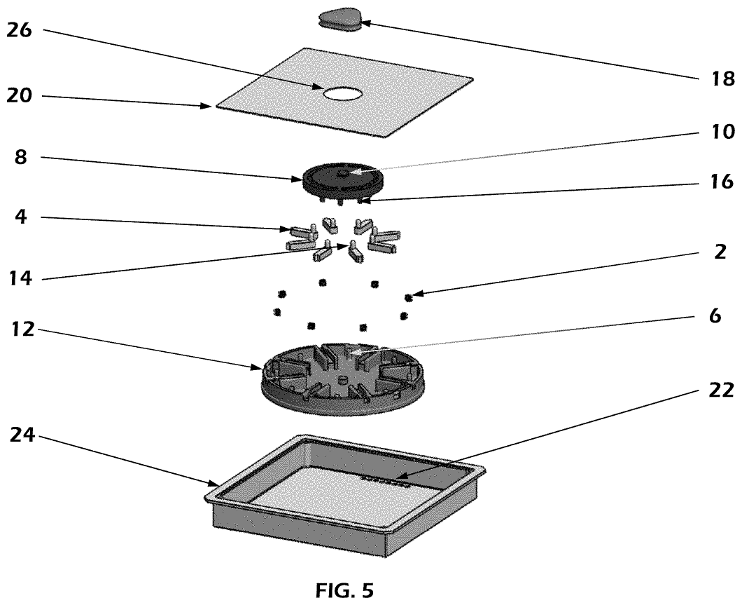

With reference to FIG. 5, an exploded view of the controller 100 is provided. As shown, FIG. 5 may illustrate a method of assembling the controller 100 and/or connection between components such as the inner disk body 8, slide pins 4 with limbs 14, buttons 2, and outer disk body 12 with slide channels 5. FIG. 5 further depicts a housing 24 and top plate 20 configured to contain the disk assembly. The housing 24 may define an interior configured to support the outer disk body 12 and the inner disk body 8 therein. Additionally, the top plate 20 may be configured to cover at least a portion of the interior of the housing 24 and may be removably attached to the housing 24 so as to provide selective access to the interior of the housing 24. The housing 24 may be configured with a cable management system 22 (e.g., openings in the bottom surface of the housing) configured to organize electrical components for the associated buttons 2 and operably connect the controller with a gaming system, computing device, etc. The top plate 20 may be configured with a through hole for the interlocking mechanism 10 to allow connection between the inner disk body 8 and a user input element 18. A plurality of input element designs, and components may be used to meet personalized criteria (e.g., shape, size, material, color, sensitivity, etc.) for the respective user.

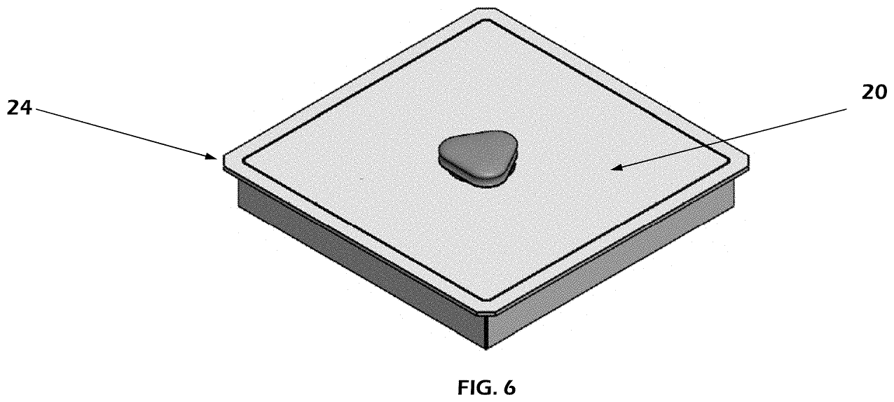

With reference to FIG. 6, the assembled controller is illustrated in which the inner disk body 8 and the outer disk body 12 are assembled and housed with housing 24 and top plate 20. The present disclosure contemplates that the housing 20 and top plate 24 may be dimensioned (e.g., sized and shaped) based upon the intended application of the controller 100. Furthermore, the housing 20 may be configured to be supported by or within a planar surface. For example, the housing 20 may be placed within an opening or recess defined by a table so as to partially or entirely support the weight of the controller 100.

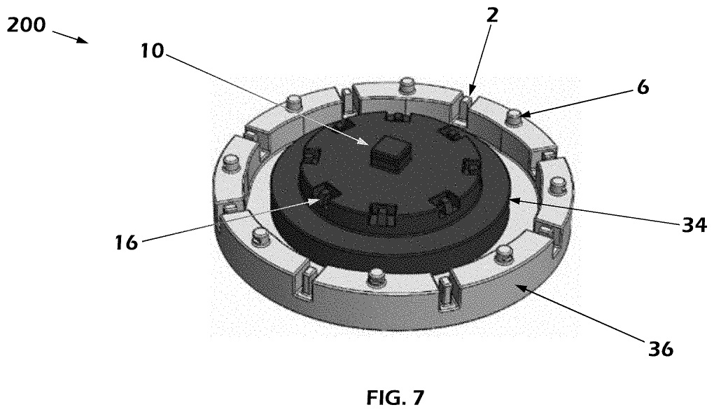

With reference to FIG. 7, another accessible gaming controller device 200 (e.g., controller 200) is shown. Although described hereinafter with reference to different potential embodiments, the present disclosure contemplates that one or more features of the controller 200 may be included, in whole or in part, in the controller 100, and vice versa. As shown in FIG. 7, an inner disk body 34 is nested within and/or supported by an outer disk body 36. The inner disk body 34 is linked with the outer disk body 12 via a plurality of mechanical springs or the like (e.g., pressurized cylinders, load absorbing devices, etc.). Such mechanisms (e.g., reset mechanisms) may be attached to a plurality of inner spring perches 16 on the inner disk body 34 and/or a plurality of outer spring perches 6 on the outer disk body 36. The plurality of inner spring perches 16 and outer spring perches 6 may be configured to connect to a spring device via an appropriately sized groove or hole in either an inner perch or outer perch. Such mechanisms may force the inner disk body 34 to return to center after user input is removed and/or reduced (e.g., a return to a neutral or resting position as described above).

With reference to FIG. 8, a top view of the controller 200 is provided. As shown, the inner disk body 34 may rest in a reset, resting, or neutral position. The inner disk body 34 may be configured to be actuated in any direction in response to user input. As such, the controller 200 also allows planar motion (e.g., from user input) to directly actuate a desired button 2. Said differently, the controller 200 may not be constrained to linear motion for button 2 action actuation. As such, in an instance a user provides input to the accessible gaming controller device with any motion that may or may not directly align with a linear path between the center of the inner disk body 34 and the button 2, a desired button 2 may still be actuated as intended.

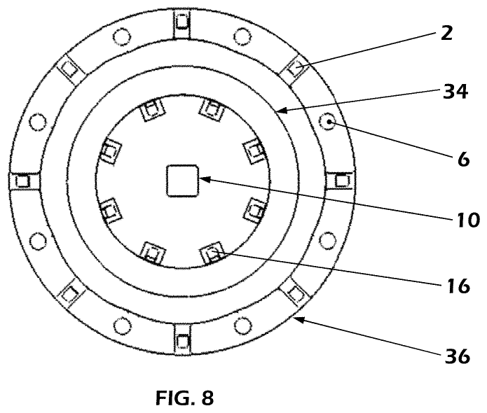

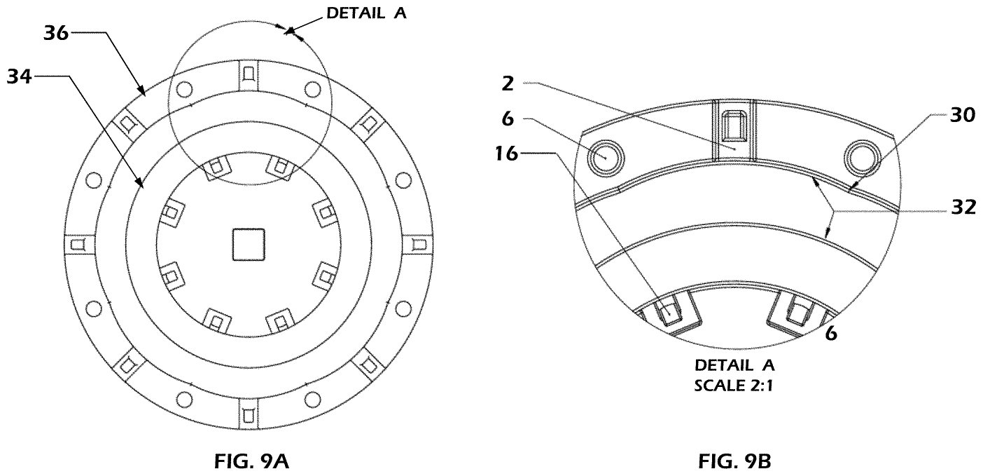

With reference to FIG. 9A and FIG. 9B, the controller 200 may be configured with a plurality of arcuate shapes defined along the perimeter of the inner wall of the outer disk body 36. Each arcuate shaped may terminate at a vertex 30 connecting the shape to an adjacent arcuate shape. Each arcuate shape may have an associated radius 32 defined along the perimeter of the inner wall of the outer disk body 36. In some embodiments, each arcuate shape may have a similar radius within an applicable engineering tolerance. The plurality of arcuate shapes may preclude an unintended actuation of one or more buttons. For example, if a user provides user input which is directed between two buttons, such as due to user error, the inner disk body 34 may encounter the vertex 32 such that a button is not unintentionally actuated. Furthermore, the arcuate shapes may be configured to direct movement of the inner disk body 34 towards a respective one of the one or more buttons.

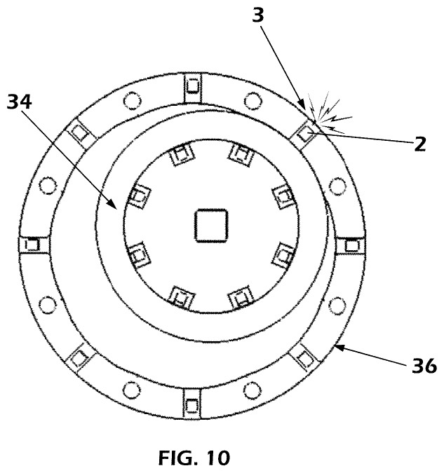

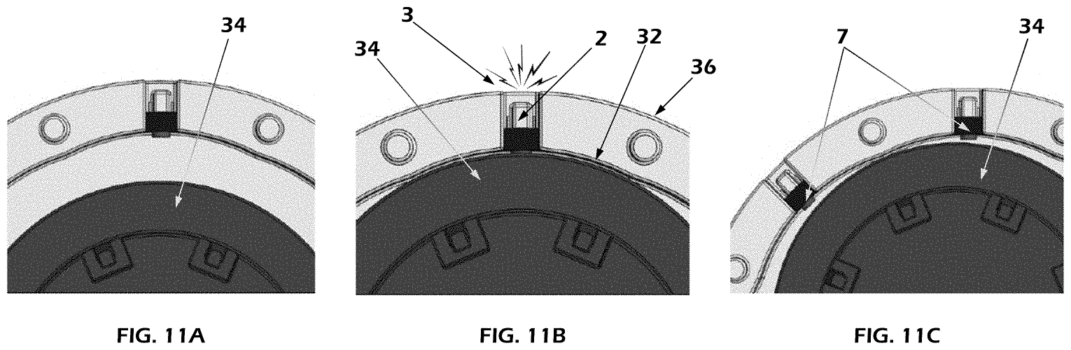

With reference to FIG. 10, a top view of controller 200 is provided in which the inner disk body 34 actuates a desired button 2. The curvature of the inner disk body 34 may be complimentary to the associated curvature of the arcuate shape such that the inner disk body 34 may be received by the arcuate shape to actuate 3 the desired button 2. With reference to FIG. 11A-11C, multiple top views of the controller 200 in a neutral position, an actuated position, and unintentional actuation position, respectively, are depicted. In particular, FIG. 11A depicts the inner disk body 34 in the centered or neutral position due to the lack of user input. FIG. 11B depicts the inner disk body 34 actuated toward a button 2 and actuating 3 the desired button 2. FIG. 11C depicts an instance where the inner disk body 34 moves in a direction that positions the inner disk body 34 between two buttons 2, such as due to unintentional user input. Both buttons 2 will remain deactivated 7 unless the user moves the inner disk body 34 to translate towards a particular button 2.

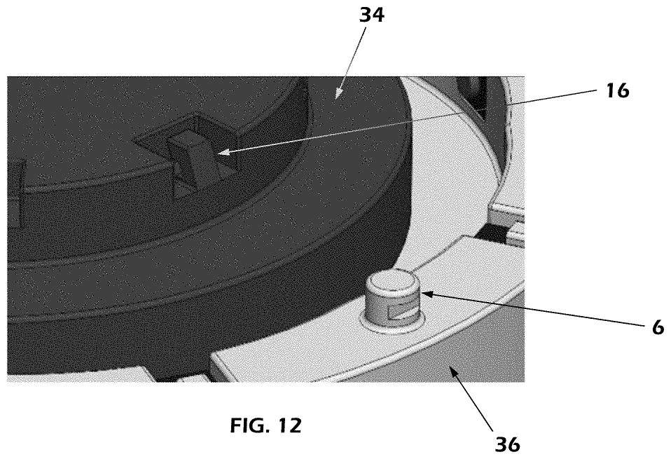

With reference to FIG. 12, an enlarged isometric view of the controller 200 is illustrated. As shown, FIG. 12 depicts the plurality of inner spring perches 16 and the plurality of outer spring perches 6 in the controller 200. The plurality of inner spring perches 16 may be manufactured as part of the inner disk body 34 (e.g., an integral body) or individually as modular components. The plurality of outer spring perches 6 may also be manufactured as part of the outer disk body 36 or as modular components. The plurality of inner spring perches 16 and plurality of outer spring perches 6 may be dimensioned (e.g., sized and shaped) so as to be connected by a mechanical spring or other types of tension or compression mechanisms (e.g., pressurized cylinders, load absorbing devices, etc.). Such mechanisms (e.g., reset mechanisms) may be attached by an appropriately sized groove or hole in either an inner spring perch 16 or an outer spring perch 6.

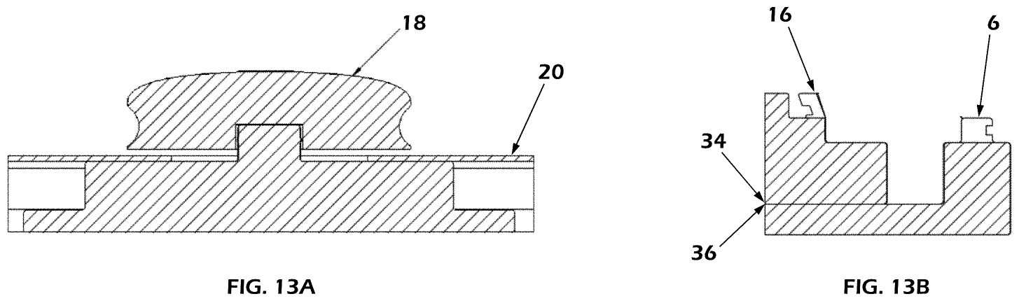

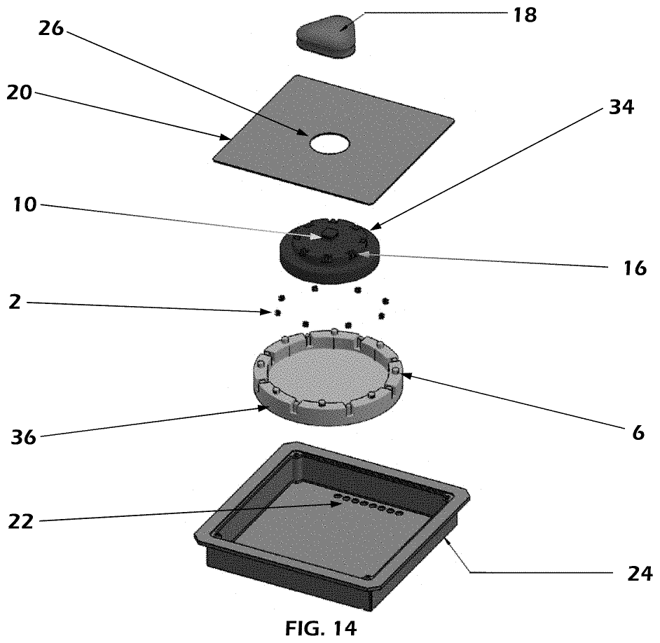

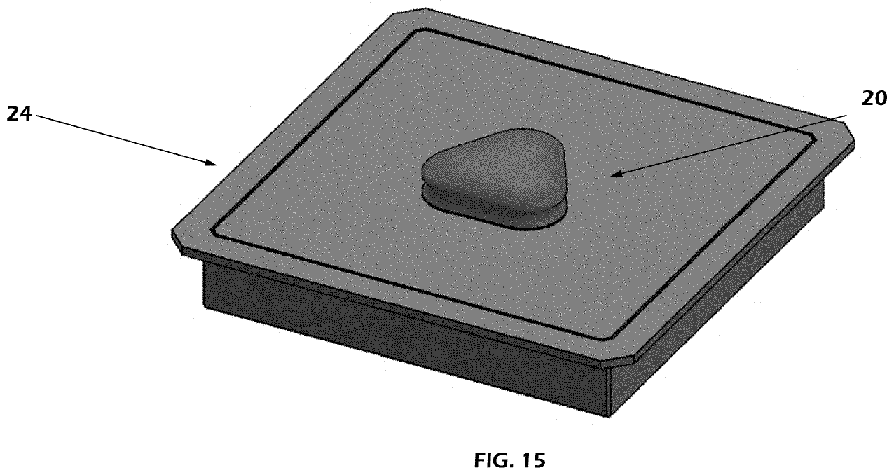

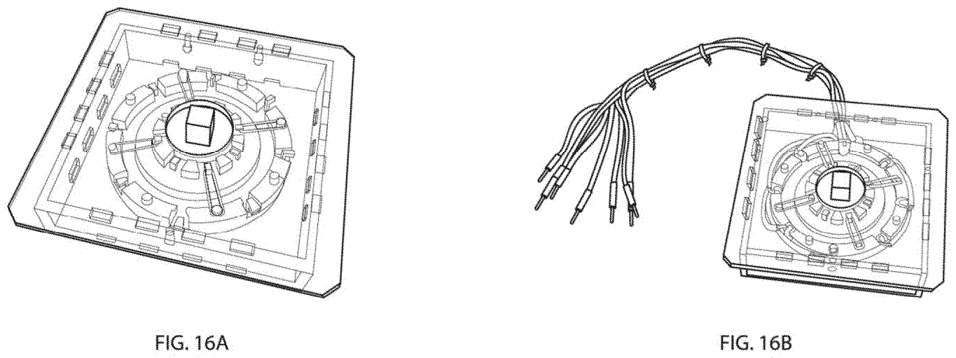

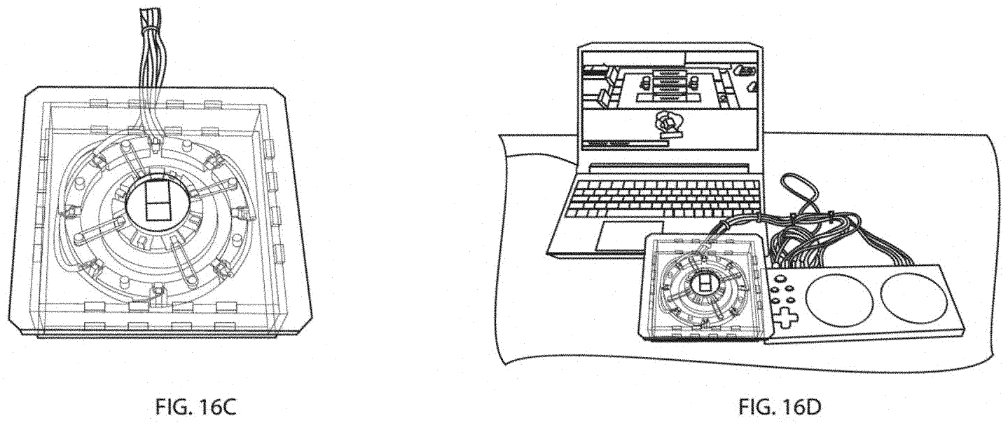

With reference to FIG. 13A and FIG. 13B, a cross sectional side view of the controller 200 is depicted. The plurality of inner spring perches 16 and the plurality of outer spring perches 6 are depicted between the surfaces of the inner disk body 34 and outer disk body 36. The controller 200 may be configured such that the inner surface of the outer disk body 36 provides a surface on which the inner disk body 34 maneuvers. This surface may allow the inner disk body 34 to translate motion, as provided via user input, on the planar surface. With reference to FIG. 14, an exploded view of the controller 200 is shown with a similar housing 24 and top plate 20 as described above with reference to FIG. 5. Similar to FIG. 6 above, FIG. 15 illustrates an exemplary embodiment of an assembled controller 200 comprising a housing 24 with a top plate 20. FIGS. 16A-16D illustrate example implementations of the accessible gaming controller devices 100, 200 of the present disclosure, such as with an example computing device or gaming system. Further, FIGS. 16A-16D illustrate example implementations of the accessible gaming controller devices 100, 200 of the present disclosure, such as with an example computing device or gaming system.

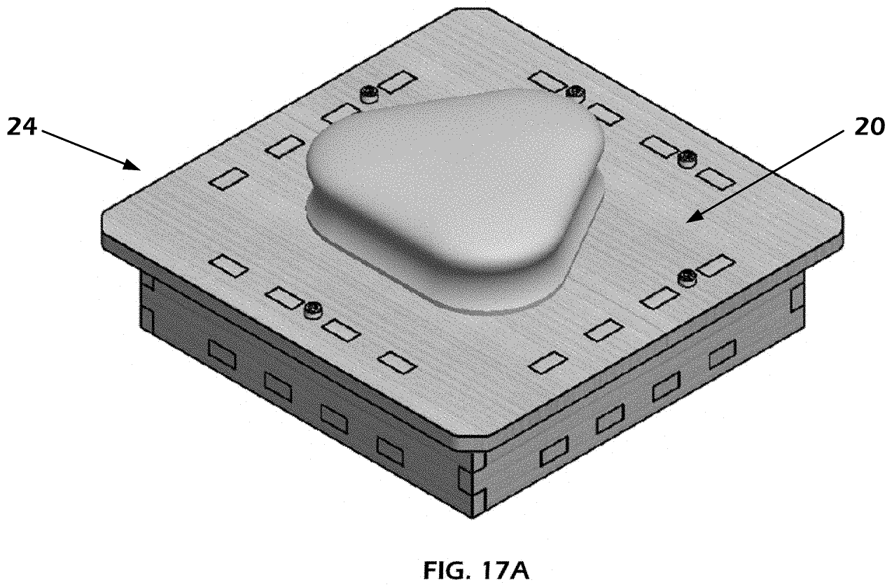

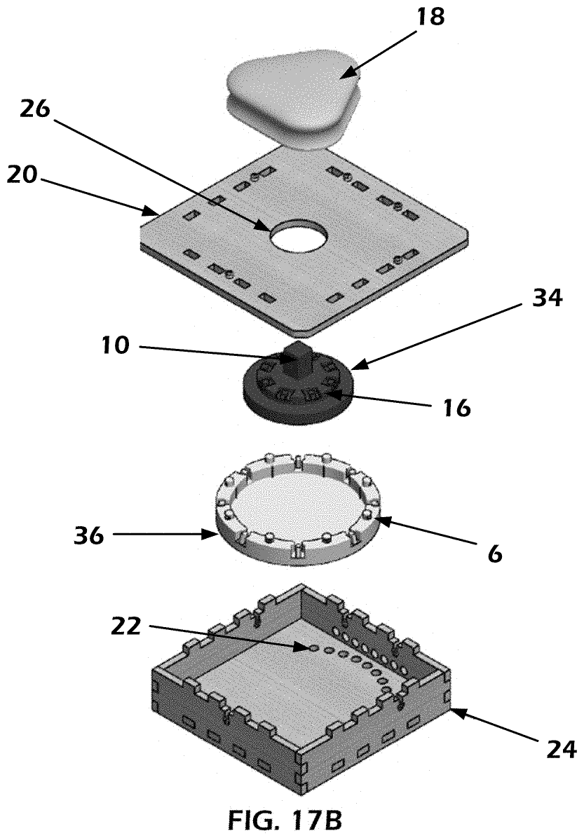

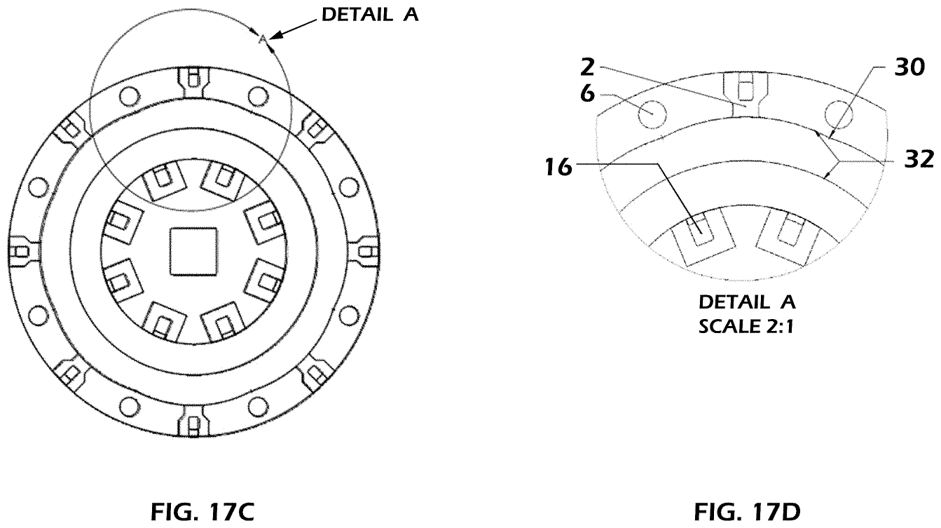

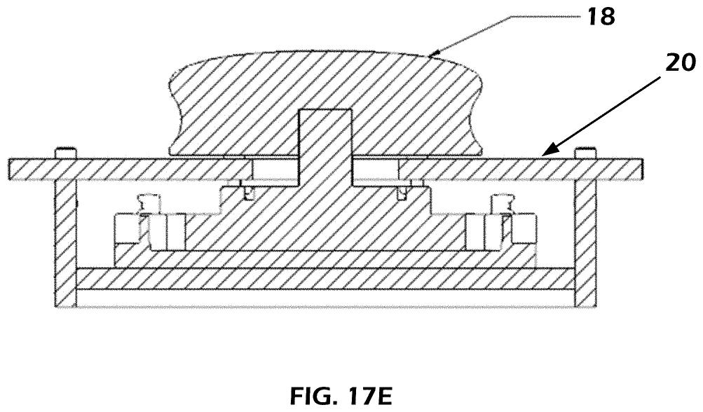

FIG. 17A illustrates an exemplary embodiment of an assembled controller 200 comprising a housing 24 with a top plate 20, similar to the exemplary embodiments illustrated in FIG. 6 and FIG. 15, as described above. With reference to FIG. 17B, an exploded view of the controller 200 is shown with a similar housing 24 and top plate 20 as described above with reference to FIGS. 5 and 14. With reference to FIGS. 17C and 17D, top views of various aspects of the exemplary accessible gaming controller device of FIGS. 17B, including an exemplary inner disk body configuration having arcuate shaped contours, as described above with reference to FIGS. 9A and 9B. With reference to FIG. 17E, a side section view of the example accessible gaming controller device of FIG. 17A in the resting position is illustrated, similar to the exemplary embodiment described above with respect to FIG. 13A.

1. A controller device comprising:
an outer disk body;
an inner disk body supported at least in part by the outer disk body and configured to translate relative to the outer disk body; and
one or more buttons defined by the outer disk body, wherein the inner disk body is configured to receive a user input that causes the inner disk body to translate relative to the outer disk body and actuate at least one of the one or more buttons.

2. The controller device according to claim 1, wherein the one or more buttons are disposed radially about a peripheral edge of the outer disk body.

3. The controller device according to claim 1, further comprising an input element operably connected to the inner disk body and configured to cause translation of the inner disk body in a direction responsive to receipt of an applied user input via the input element.

4. The controller device according to claim 1, further comprising:
a housing defining an interior configured to support the outer disk body and the inner disk body therein; and
a top plate configured to cover at least a portion of the interior of the housing.

5. The controller device according to claim 4, wherein the top plate is removably attached to the housing so as to provide selective access to the interior of the housing.

6. The controller device according to claim 5, wherein the top plate further comprises an opening configured to receive an input element operably connected to the inner disk body therein such that the input element extends at least partially through the opening.

7. The controller device according to claim 4, wherein the housing defines one or more openings defined by a bottom surface of the housing opposite the top plate.

8. The controller device according to claim 7, wherein the one or more openings of the bottom surface are configured to communicably couple the controller device to a gaming system via one or more cables disposed within the one or more openings.

9. The controller device according to claim 1, wherein:
the inner disk body further defines a plurality of radial slots, and
the controller device further comprises a plurality of slide pins configured to be positioned within respective radial slots of the plurality of radial slots.

10. The controller device according to claim 9, wherein each slide pin defines a limb configured to slot within the respective radial slot.

11. The controller device according to claim 1, wherein the outer disk body further defines a plurality of slide channels, each slide channel defining a translation path to a respective button of the one or more buttons.

12. The controller device according to claim 11, wherein the translation path defines a linear path along which the respective slide pin travels.

13. The controller device according to claim 11, wherein each button of the one or more buttons is positioned at a distal end of a respective translation path.

14. The controller device according to claim 13, wherein, in response to a user input, the slide pin translates along the translation path in a first direction so as to actuate a first button positioned at the distal end of the translation path in the first direction.

15. The controller device according to claim 1, further comprising a reset mechanism configured to, following removal of a user input, reset the inner disk body to a resting position.

16. The controller device according to claim 15, wherein the reset mechanism comprises a plurality of springs configured to urge the inner disk body to the resting position.

17. The controller device according to claim 16, wherein each of the plurality of springs is configured to urge the inner disk body in a direction opposite a direction associated with a user input configured to actuate a respective button.

18. The controller according to claim 1, wherein the outer disk body further defines a plurality of arcuate shapes positioned at respective buttons along a peripheral edge of the outer disk body.

19. The controller according to claim 18, wherein the plurality of arcuate shapes are configured to preclude an unintended actuation of one or more buttons.

20. The controller according to claim 18, wherein each of the plurality of arcuate shapes are configured to direct movement of the inner disk body towards a respective one of the one or more buttons.
